(19) United States
(12) Patent Application Publication
(10) Pub. No.: US 2011/0218862 A1
(43) Pub. Date: Sep. 8, 2011

(54) MANUFACTURER-LINKED LANDING PAGE FOR ONLINE ADVERTISING

(75) Inventors: Jackie Langston, Roswell, GA (US); Timothy Oakhill, Atlanta, GA (US)

(73) Assignee: Dreamwell, Ltd., Las Vegas, NV (US)

(21) Appl. No.: 12/945,397

(22) Filed: Nov. 12, 2010

Related U.S. Application Data
(60) Provisional application No. 61/261,044, filed on Nov. 13, 2009.

(51) Int. Cl. G06Q 30/00

(52) U.S. Cl. 705/14.69; 705/27.1

(57) ABSTRACT

The systems and methods described herein provide manufacturer-linked landing pages for online advertising. A retailer may sell products manufactured by a number of different manufacturers. A manufacturer may pay the retailer to advertise products they manufacture. The retailer may advertise itself or products or product types it sells online. On responding to such advertisements, a user may be first directed to a landing page. The landing page may be the primary web page of the retailer, or a web page containing some subset of products or product types that the retailer sells. A landing page for the retailer may simultaneously display products from different manufacturers. If a particular manufacturer has paid for some portion of the advertising for that retailer, it may be desirable from the perspective of the manufacturer for advertisements to lead to landing pages that only display products that they manufacture, and exclude products from other manufacturers.

### CROSS-REFERENCE TO RELATED APPLICATIONS

This application claims priority to and the benefit of U.S. Provisional Patent Application Ser. No. 61/261,044, filed Nov. 13, 2009 and entitled “Manufacturer-Linked Landing Page for Online Advertising”, the entire contents of which are incorporated herein by reference.

### BACKGROUND

Advertising over interactive media has become popular in recent years. For example, as the number of people using the Internet has multiplied, advertisers have begun to target consumers online. Internet advertising provides opportunities for advertisers to target their ads to a receptive audience. Targeted ads are more likely to be useful to an online consumer since the ads may be relevant to a need inferred from some user activity, for example, a search query to a search engine. Query keyword targeting has been used by search engines, for example, Google, to deliver targeted ads. For example, if a user searches for reviews on king mattresses, the search results may include targeted advertisements from different mattress manufacturers. However, such advertising systems still have room for improvement. In particular, the search results often include results from different mattress retailers each selling several products from several different manufacturers. Consumers looking for a particular brand may be overwhelmed by the options offered by these retailers. Accordingly, there is a need for improved systems and methods that can provide targeted advertising for consumers without overwhelming them.

### SUMMARY

The systems and methods described herein provide such a solution by directing consumers to a landing page or a lead capture page before the originally intended target of the online advertisement or search result is displayed. The systems and methods described herein provide manufacturer-linked landing pages for online advertising. A retailer or business may sell a variety of products manufactured by a number of different manufacturers. One or more of these manufacturers may pay the retailer or business to advertise their products. Using this payment, the retailer may advertise itself or one or more of the products or product types it sells online, via advertisements on web pages or via advertisements transmitted directly to a user by, for example, email. When a user responds to these advertisements or to search engine results linking to the retailer, the user may be first directed or linked to a web page known as a landing page. The landing page may be the primary web page of the retailer, or a web page that contains some subset of the products or product types that the retailer sells. Since most retailers sell products from a number of different manufacturers, a landing page for a retailer may simultaneously display products from different manufacturers. If a particular manufacturer or group of manufacturers has paid for some portion of the advertising for that retailer, it may be desirable from the perspective of the manufacturer(s) to control some of the displayed content. For example, a manufacturer may desire web links and/or online advertisements to lead to landing pages that display products that they manufacture, and exclude products from other, competing manufacturers.

In one example, manufacturer A may manufacture mattresses that a retailer B sells. The systems and methods described herein allow the manufacturer A to provide a payment to retailer B for advertising online. Retailer B, in turn, using the systems and methods pays an online advertising company, such as Google, to present advertisements for retailer B to users who have performed online searches related to mattresses. When a user clicks on the advertisements or on a search results link, he may be linked to a customized landing page that only displays information about mattresses from manufacturer A, and not information about mattresses from other manufacturers that retailer B may sell. The customized landing page may also include links to the homepage of retailer B, or links to certain portions of retailer B's online storefront, such as the portion of retailer B's storefront that sells mattresses from manufacturer A. This customized landing page may be served to the user from either a server associated with retailer B or a server associated with manufacturer A. In some embodiments, the server may determine whether the customized landing page or a standard page associated with retailer B is to be displayed to a user. This determination may be based, for example, on the proportion of retailer B's online advertising payment that comes from manufacturer A. For example, if manufacturer A provides 25% of retailer B's online advertising payment, the server may direct 25% of the incoming users to the customized landing page.

In one aspect, the systems and methods described herein include a processor, a network interface, and a memory. The processor may receive a request for a web page associated with a retailer and having a web link that includes information to identify a type of product sold by the retailer and manufactured by one or more manufacturers. In some embodiments, the web link may be associated with an advertisement or search engine result. The processor may send to a user a landing page displaying content representative of a plurality of versions of the type of product sold by the retailer. In some embodiments, each version of the type of product is associated with a selected one of the manufacturers. The processor may select content for the landing page as a function of an advertising payment from each manufacturer. In some embodiments, the landing page may include content related to versions manufactured by a first manufacturer of the one or more manufacturers. In some embodiments, the landing page may include content comparing versions manufactured by a first manufacturer and a second manufacturer of the one or more manufacturers. The processor may generate the landing page with the selected content for display to the user. In some embodiments, the landing page may be controlled by the retailer, the one or more manufacturers, or a combination thereof. In some embodiments, the processor may select content for the landing page based on the originating location of the request from the included web link. The web link may include information identifying one or more of a Uniform Resource Locator (URL), an Internet Protocol (IP) address, an entity associated with a website that includes the web link, and/or a region where the website is hosted. The processor may identify the originating location and determine one or more rules associated with the originating location. The processor may then select content for the landing page based on the determined rules.

In another aspect, the systems and methods described herein include a processor, a network interface, and a memory. The processor may receive a request for a web page associated with a retailer and having a web link that includes information to identify a type of product sold by the retailer and manufactured by one or more manufacturers. The processor may send to a user a landing page as a function of an advertising payment from each manufacturer. The landing page may be controlled by a selected manufacturer. The landing page may display content representative of a plurality of versions of the type of product associated with the selected manufacturer. The processor may retrieve content for the landing page provided by the selected one of the manufacturers. The processor may generate the landing page with the retrieved manufacturer provided content for delivery to the user.

### BRIEF DESCRIPTION OF THE FIGURES

The foregoing and other objects and advantages of the invention will be appreciated more fully from the following further description thereof, with reference to the accompanying drawings wherein:

FIG. 1 depicts a series of graphical screens including a landing page screen that are displayed to the user, according to an illustrative embodiment of the invention;

FIG. 2 is a schematic diagram depicting landing page content being controlled by a retailer and a manufacturer, according to an illustrative embodiment of the invention;

FIG. 3 is a schematic diagram of a system for generating a landing page, according to an illustrative embodiment of the invention;

FIG. 4 depicts a server for generating a landing page, according to an illustrative embodiment of the invention;

FIG. 5 depicts more specifically a web page, according to an illustrative embodiment of the invention;

FIG. 6 depicts more specifically the components of a landing page, according to an illustrative embodiment of the invention;

FIG. 7 depicts a process for generating and displaying a landing page, according to an illustrative embodiment of the invention;

FIG. 8 depicts a process for generating and displaying a landing page, according to another illustrative embodiment of the invention; and

FIGS. 9A-9C depict flow diagrams for the operation of a system when generating a landing page, according to an illustrative embodiment of the invention.

### DETAILED DESCRIPTION

To provide an overall understanding of the invention, certain illustrative embodiments will now be described, including systems and methods for online advertising via manufacturer-linked landing pages. However, it will be understood by one of ordinary skill in the art that the systems and methods described herein may be adapted and modified for other suitable applications and that such other additions and modifications will not depart from the scope thereof.

In many aspects, the systems and methods described herein provide manufacturer-linked landing pages for online advertising. A retailer or business may sell a variety of products manufactured by a number of different manufacturers. The products may be the same product types, such as mattresses, manufactured or distributed by a number of competing companies. One or more of these manufacturers may pay the retailer or business to advertise their products. Using this payment, the retailer may advertise itself or one or more of the products or product types it sells online, via advertisements on web pages or via advertisements transmitted directly to a user by, for example, email. When a user responds to these advertisements or to search engine results linking to the retailer, the user may be first directed or linked to a web page known as a landing page. The landing page may be the primary web page of the retailer, or a web page that contains some subset of the products or product types that the retailer sells. Since most retailers sell products of the same product type from a number of different manufacturers, a landing page for a retailer may simultaneously display products of the same product type from different manufacturers. If a particular manufacturer or group of manufacturers has paid for some portion of the advertising for that retailer, it may be desirable from the perspective of the manufacturer(s) to control some of the displayed content. For example, a manufacturer may desire web links and/or online advertisements to lead to landing pages that display products that they manufacture, and exclude products from other, competing manufacturers.

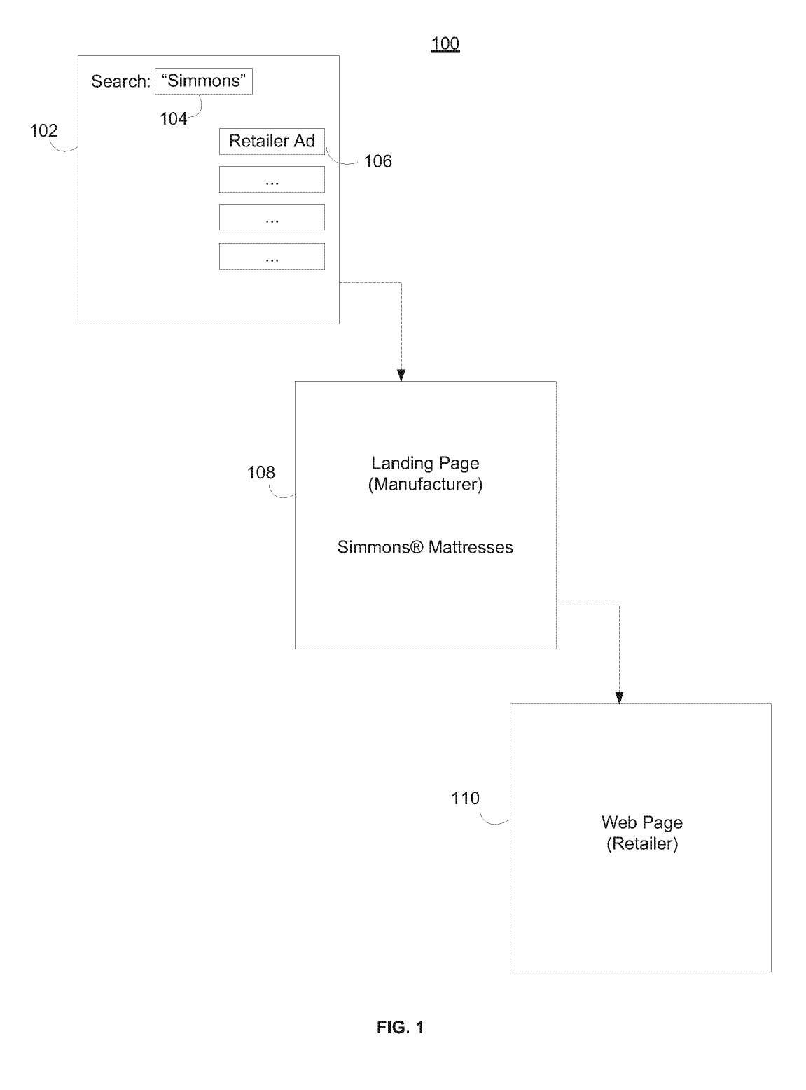

FIG. 1 depicts a series of graphical screens 100 including landing page 108 that may be displayed to a user of a landing page system according to an embodiment of the invention. For example, a user may navigate to a search portal web page 102, such as Google® or Yahoo®.

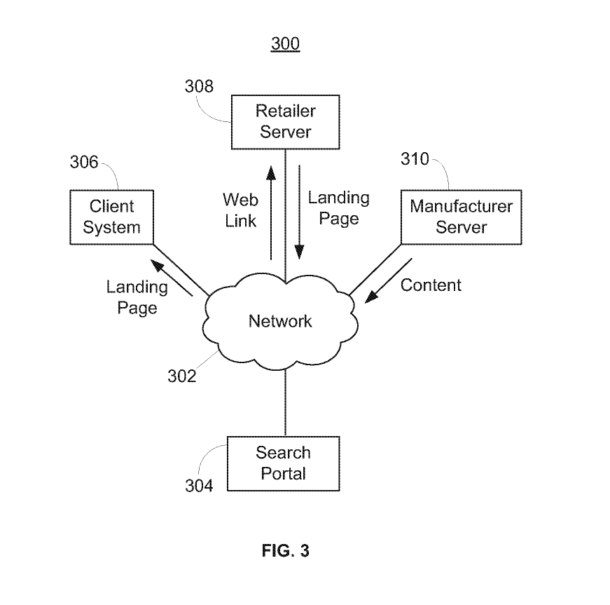

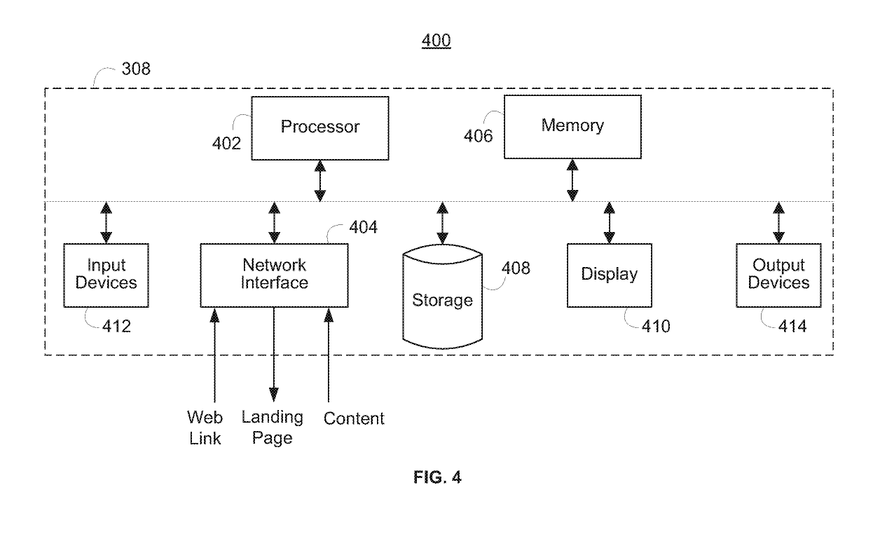

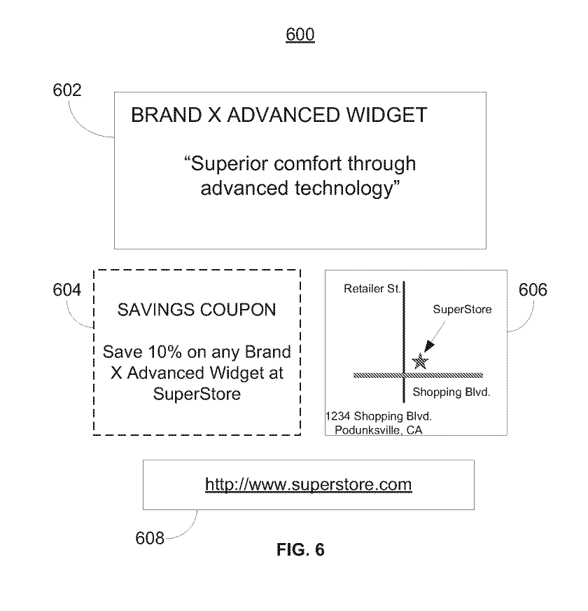

FIG. 1 depicts an illustrative embodiment of such a web page. The search portal delivers a search page to the client browser, the user enters search terms into the search page, and the browser transmits the search terms back to the server of the search portal. For example, the user may enter keyword “Simmons” in search box 104 at search portal web page 102. The search portal may generate a web page that is transmitted back to be displayed by the client browser. The web page may include search results, including links that point to web sites related to the search terms submitted by the user, and may also include a set of hypertext links as sponsored links, e.g., sponsored link 106. The sponsored links may point to the servers of companies and entities that have purchased space on the web page, so that a hypertext link to their web site is placed on the web page whenever, or at least some of the time, a user enters a search term, e.g., “Simmons”. Sponsored link 106 may be related to keyword “Simmons” and may have been bought and paid for by the retailer. On clicking sponsored link 106, the user may be directed to retailer web page 110. However, before retailer web page 110 is displayed, landing page 108 is displayed to the user. FIG. 6 depicts an illustrative embodiment of a landing page. Landing page 108 is generated by a landing page server in response to the user clicking on sponsored link 106. FIG. 4 depicts an illustrative embodiment of a retailer server for generating such a landing page. The landing page content may be controlled by the manufacturer, such as Simmons®, and landing page 108 may display products manufactured by Simmons® and sold by the retailer. On further clicking a link on landing page 108, the user may be directed to web page 110 associated with the retailer or, in some embodiments, to the manufacturer. An embodiment of a system that may generate the user screens 102, 108, and 110 is illustrated in FIG. 3. In one example, web page 102 may display search results along with advertisement or sponsored links. On clicking a sponsored link, the user may be directed to landing page 108. The landing page may be overlaid on top of web page 102 or retailer web page 110, occupying a part or whole of the screen. The user may be directed to a landing page in the same or a new browser window. The landing page may be shown for a fixed period of time before the user is directed to retailer web page 110. The user may be given the option to exit the landing page via one or more controls or through a link to retailer web page 110. A more detailed description of a landing page and related content is described with reference to FIG. 6.

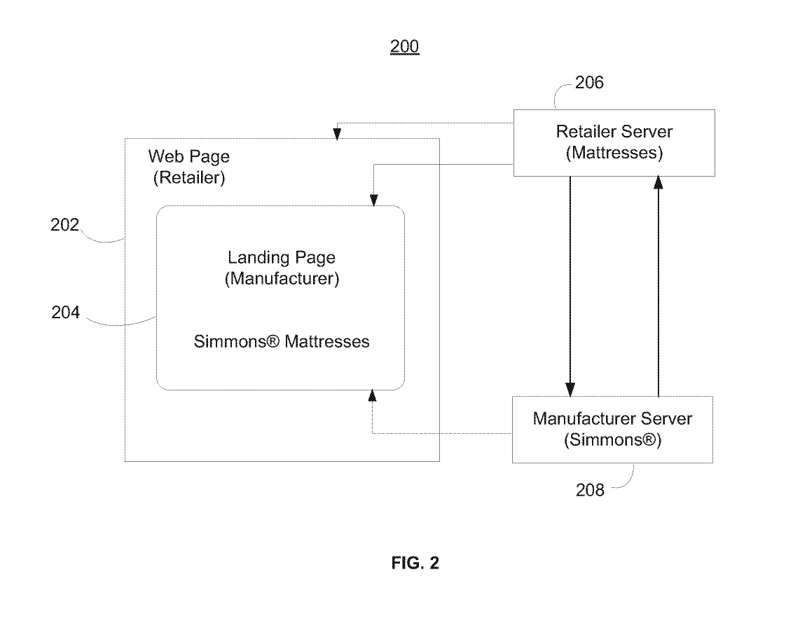

FIG. 2 is a schematic diagram 200 depicting how landing page content may be controlled by a retailer and a manufacturer, according to an illustrative embodiment of the invention. Retailer server 206 generates retailer web page 202 and landing page 204 for display to the user. FIG. 6 depicts an illustrative embodiment of a landing page. In the process, retailer server 206 is tasked with gathering content for the landing page. In the embodiment shown, the landing page content is controlled by a manufacturer. Accordingly, retailer server 206 requests and/or retrieves content for the landing page from manufacturer server 208. Landing page 204 may include content related to versions of a type of product sold by the retailer and manufactured by a selected manufacturer. For example, a retailer may sell mattresses from multiple manufacturers, including mattresses manufactured by Simmons®. The retailer may retrieve content for the landing page from a server operated by Simmons®. In this example, a user may be displayed landing page 204 including only mattresses sold by the retailer and manufactured by Simmons®. In some embodiments, retailer server 206 may pass on the task of landing page content selection and generation to manufacturer server 208 (illustrated by the dotted line). In some embodiments, landing page content may be controlled by the retailer, one or more manufacturers, or a combination thereof. For example, a template for the landing page may be stored in memory in retailer server 206 while content related to products to be displayed on the landing page may be retrieved from manufacturer server 208. If manufacturer server 208 is unavailable, retailer server 206 may retrieve landing page content from its own memory in order to generate the landing page. Retailer server 206 may select content based on an agreement between the retailer and the manufacturer, e.g., selection may be based on the last set of instructions/content from manufacturer server 208. FIG. 3 shows an illustrative embodiment of a system that implements the schematic diagram of FIG. 2.

FIG. 3 depicts schematically an embodiment of a landing page system that includes a data network 302 (e.g., the Internet), a server 304 that can be set up and operated by a search portal service, such as Google, Inc., Yahoo! Inc, or any other site that sells advertising space, such as banner ad space, or sponsored links sections. In this example, the server 304 is for a search portal such as Google. The data network 302 interconnects the search portal 304 with a user at a client system 306 and also connects to servers maintained by an advertiser (retailer) and by a manufacturer, servers 308 and 310 respectively. In some embodiments, the data network 302 interconnects search portal 304, client system 306, and retailer server 308 only. The server processes shown in FIG. 3 may be any suitable server processes that will generate and serve pages, including the Apache server, modified with Perl scripts or other extensions. Suitable servers and extensions are well known in the art and are described, among other places, in Jamsa, Internet Programming, Jamsa Press (1995), the teachings of which are herein incorporated by reference. Additionally, the servers and processes described herein may employ CGI scripts or other extension techniques to generate the web pages and hypertext links that direct interaction among the different servers. These processes can be developed using any conventional techniques including any of the techniques described in Graham, HTML Sourcebook, Wiley Computer Publishing (1997) the teachings of which are also herein incorporated by reference. The server processes and the client processes are usually computer programs and they operate on data processing systems, which typically are conventional data processing platforms such as an IBM PC-compatible computer running the Windows operating systems, or a SUN workstation running a Unix operating system.

The search portal 304 may operate as a standard search portal, having a sponsored link server program that processes the search terms submitted by the user from the client system 306. To that end, the client system 306 includes a browser program that sends http requests to the search portal 304. The search portal delivers a search page to the client browser, and the user enters search terms into the search page and the browser transmits the search terms back to the server of the search portal. The search portal executes the sponsored links server and generates a web page (e.g., 102 in FIG. 1) that is transmitted back to the client system 306 and displayed by the client browser. The web page includes search results, including links that point to web sites related to the search terms submitted by the user, and also includes a set of hypertext links as sponsored links. These sponsored links point to the servers of companies and entities that have purchased space on the web page, so that a hypertext link to their web site is placed on the web page whenever, or at least some of the time, a user enters certain search terms, such as “mattress”. In this example, the web page includes as a sponsored link a hypertext link to the retailer's web site server. In some embodiments, the links that point to web sites related to the submitted search terms may also point to the servers of relevant companies and entities. For example, if a user submitted the name of a company as a search term, the returned search results web page may include at least one link to the company. In these embodiments, the companies may not pay or be able to pay for links to their servers to be displayed in the search results, even though they may have purchased sponsored links.

The retailer's web server may include a landing page server. The landing page server may be, for example, a computer program and/or system, which generate the appropriate landing page (e.g., 108 in FIG. 1) to deliver to a client browser that has activated a web link on the web page generated by the search portal. In one embodiment, the landing page server processes the http string provided from the client browser due to activation of the web link, for example, the search results link and/or sponsored link, on the search portal web page. In some embodiments, if a search results link has been activated, the http string provided from the client browser may include information about the referring search engine. For example, the http string of the web link may include information that the activated link was referred by Google. The web link may include information identifying one or more of a Uniform Resource Locator (URL), an Internet Protocol (IP) address, an entity associated with a website that includes the web link, and/or a region where the website is hosted. In other embodiments, software components executed on the landing page server may determine the referral information associated with an activated search results link. For example, the software on the landing page server may be able to determine that a particular activated search results link was a Google search results link, or was a Yahoo! Search results link.

The search results link and/or sponsored link may include a hypertext link to a Perl script or script in some other programming language associated with the landing page server. The Perl script may be executed by a processor in the landing page server to determine the appropriate landing page to deliver to the client. For example, the Perl script may always provide a web page that includes content associated with the manufacturer, as described above. Alternatively, as shown in the embodiment in FIG. 3, the Perl script may retrieve content from the manufacturer's server 310, where that server 310 determines what content to deliver to the user. The Perl script may also choose to serve the retailer traditional home page as well. The determination of whether to serve the retailer's home page, or to serve a page associated with a manufacturer may depend on the percentage of the retailer's web advertising budget that has been under written by each manufacturer or upon some other criteria agreed to by the parties. In some embodiments, the determination may be made as a function of advertising payments from each manufacturer. In some embodiments, the landing page may include content related to versions manufactured by a first manufacturer of the one or more manufacturers. In some embodiments, the landing page may include content comparing versions manufactured by a first manufacturer and a second manufacturer of the one or more manufacturers. Determination of landing page content may also take into account the referring party or parties. Landing page content may also be determined based on different co-op advertising programs that one or more manufacturers pay to the retailer. In some embodiments, the retailer may be able to auction off the landing page content to the different manufacturers. In still other embodiments, location-based information of the user may be used to determine the landing page content.

In some embodiments, the landing page content may be based on the originating location of the request from the included web link. The web link may include information identifying one or more of a Uniform Resource Locator (URL), an Internet Protocol (IP) address, an entity associated with a website that includes the web link, and/or a region where the website is hosted. For example, a landing page request originating from a search engine result, e.g. Google, may be treated differently than a landing page request originating from a different web site or location, such as a link from an online New York Times article. Content for the landing page may be selected per one or more rules determined based on the originating location. The landing page server may change the landing page presented to the client such that a landing page, as described above, is delivered.

FIG. 4 depicts a retailer server from the embodiment shown in FIG. 3. Retailer server 400 may include processor 402, network interface 404, memory 406, input devices 412, storage devices 408, display device 410, and output devices 414. Retailer server 400 may communicate over network 302 (FIG. 3), through the network interface 404. Processor 402 may be from microprocessor series such as Intel Pentium, Intel Core, Intel Core 2, Intel Xeon, AMD Athlon, AMD Phenom, IBM Power, IBM PowerPC, or other such microprocessor series. Memory 406 may include read-only (ROM), or random access (RAM) memories, such as a synchronous dynamic random access memory (SDRAM), capable of storing data as well as instructions to be executed by processor 402. Input devices 412 may include a keyboard, a mouse, a trackball, or other suitable devices. Network interface 404 may include a network card, a modem, or other suitable devices. Storage 408 may include a hard disk drive (HDD), a flash drive, a floppy drive, a compact disc (CD), a digital versatile disc (DVD), or other suitable fixed or movable computer readable media. Display 410 may include one or more liquid crystal display (LCD) or cathode ray tube (CRT) monitors, or other suitable devices. Output devices 414 may include a projector, a printer, speakers, or other such devices.

A landing page server may be executed by processor 402 of retailer server 400. Network interface 404 receives a request for a web page having a web link and passes on the request to processor 402. In some embodiments, the web link may be associated with a retailer and may include information to identify a type of product sold by the retailer and manufactured by one or more manufacturers. In some embodiments, the web link may be associated with an advertisement or search engine result. Processor 402 proceeds to generate a landing page for display to the user. In the process, processor 402 selects content for the landing page, for example, as a function of an advertising payment from each manufacturer. In some embodiments, the landing page may include content related to versions manufactured by a first manufacturer of the one or more manufacturers. In some embodiments, the landing page may include content comparing versions manufactured by a first manufacturer and a second manufacturer of the one or more manufacturers. In the embodiment shown in FIG. 4, the landing page content is controlled by a manufacturer and processor 402 retrieves content from manufacturer server 310 via network interface 404. The received content may be stored in a database in memory 406. Memory 406 may contain other content, for example, a design template for the landing page, that processor 402 may retrieve in order to generate the landing page. In other embodiments, landing page content may be controlled by the retailer, one or more manufacturers, or a combination thereof. In some embodiments, processor 402 selects content for the landing page based on the originating location of the request from the included web link. For example, processor 402 receives an Internet Protocol (IP) address associated with the web link request and processes the information to calculate the user's location. Processor 402 may display a map, e.g., map 606 in FIG. 6, showing retailer locations associated with the retailer and/or the product nearest to the location of the user. The map may also include directions to the mapped retailer locations.

In some embodiments, the landing page server may be realized as a software component operating on a conventional data processing system such as a Unix workstation. The landing page server may deliver and receive content, such as web pages, using the http protocol. The landing page server may utilize server-side scripting to fulfill user requests by running a script directly on the web server to generate dynamic web pages. Scripting may allow for interactive web sites that interface to databases or other data stores, for example, a content database stored in memory 406. The landing page server may be implemented as a C language computer program, or a computer program written in any high level language including C++, Fortran, Java, one or more languages under the .NET framework, or different flavors of BASIC. General techniques for high level programming are known, and set forth in, for example, Stephen G. Kochan, Programming in C, Hayden Publishing (1983).

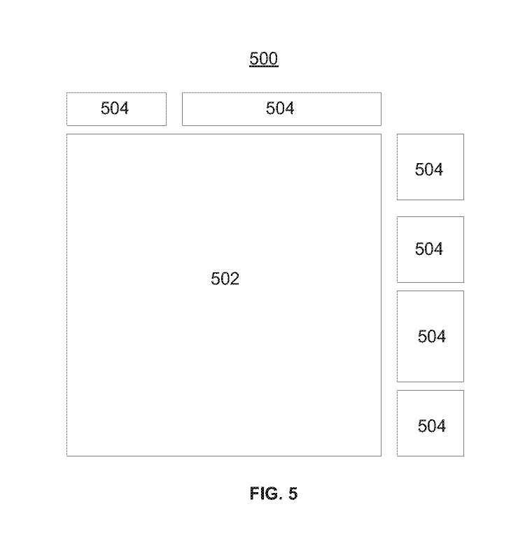

FIG. 5 depicts a web page 500 according to an illustrative embodiment of the invention. Web page 500 may include content area 502 and advertisement areas 504. Content area 502 and advertisement areas 504 may contain text, images, and/or embedded media such as video or sound clips. In some embodiments, one or more hypertext links, which are well-known in the art, may be embedded in content area 502 or advertisement areas 504. For example, a user may click on a particular section of text or a particular image in content area 502 or advertisement areas 504 to activate a hypertext link. In some embodiments, activating a hypertext link may display other content, such as a video clip, an image, or a different webpage. The other content may replace web page 500, or may be displayed as a pop-up window, which may obscure part of web page 500. In some embodiments, the web page 500 may be a search engine search results web page, and the content area 502 may include search results web links. These search results web links may be for a particular retailer or business, or for a particular product or type of product sold by a particular retailer or business (e.g., 102 in FIG. 1).

In some embodiments, advertisement areas 504 include advertisements for one or more retailers or businesses. Optionally, content area 502 may also include advertisements. The advertisements may be for a particular retailer or business, or for a particular product or type of product sold by a particular retailer or business. A user viewing an advertisement may select the advertisement, for example by clicking on the advertisement (e.g., 106 in FIG. 1). Optionally, if the content area 502 includes search results web links, a user may select a search result web link leading to a particular retailer or business. In some embodiments, after a user selects an advertisement or a search result web link, a landing page may be displayed (e.g., 108 in FIG. 1). The landing page may replace web page 500, or may be displayed as a pop-up window.

FIG. 6 depicts a landing page 600 according to an illustrative embodiment of the invention. Landing page 600 may be displayed when a user selects a web link associated with, or example, an advertisement or a search result, from web page 500. Landing page 600 may include an advertisement 602, a coupon 604, a map 606, and a hyperlink 608, and may also include other content, such as embedded video, sound, or other media content. In some embodiments, the content displayed on landing page 600 may be associated with products from one or more manufacturers. In particular embodiments, the content displayed may be associated with a product or products from a single manufacturer. For example, in FIG. 6, landing page 600 may be displayed to a user after the user selects a web link associated with a search result for SuperStore. In alternate embodiments, landing page 600 may be displayed to a user after the user selects a web link associated with an advertisement for Brand X Advanced Widget, or widgets in general. The SuperStore may sell widgets from several different manufacturers. However, landing page 600 may only display information about a particular widget from a particular manufacturer, Brand X Advanced Widget. In other embodiments, landing page 600 may display information about products from other manufacturers. For example, landing page 600 may include content that compares products from different manufacturers. Landing page 600 may be optimized for viewing on one or more different devices. For example, landing page 600 may have a television version, a desktop/laptop version, a smartphone version, and/or a cellphone version, each sized and configured for display on the appropriate device. The components of landing page 600 (e.g., advertisement 602, coupon 604, map 606, hyperlink 608) may be configured to display appropriately on each device.

Landing page 600 may include one or more advertisements 602. Advertisement 602 may advertise a product or products available for purchase from the advertising business. In certain embodiments, advertisement 602 may only advertise a product or products from a particular manufacturer. Optionally, advertisement 602 may compare multiple products from the same manufacturer or from different manufacturers. In some embodiments, advertisement 602 may include text and/or embedded media such as video or sound clips. For example, advertisement 602 may include a video clip advertising a product or products. Advertisement 602 may also include hyperlinks to other web pages (not shown). For example, advertisement 602 may include a hyperlink to the home page of the advertised product's manufacturer, or a hyperlink to the manufacturer product page. In some embodiments, advertisement 602 may include hyperlinks to other, third-party web pages, such as a web page containing a third-party review of one or more of the advertised products.

Landing page 600 may include content such as coupon 604. Coupon 604 may offer a discount on products and/or services, a rebate, or some other customer incentive. Coupon 604 may be associated with a particular manufacturer or a particular product or product type associated with a particular manufacturer. Coupon 604 may be valid at any retailer that sells that particular product or products from that particular manufacturer, or may only be valid at a particular retailer, or in a particular geographic region. For example, in FIG. 6, coupon 604 offers a discount on a Brand X Advanced Widget at SuperStore. In some embodiments, coupon 604 may be printed out by the user and redeemed at a retailer location. Optionally, coupon 604 may offer a coupon code that may be redeemed at a retailer location or during an online purchase at the retailer web page.

Landing page 600 may also include content such as map 606. Map 606 may depict the location(s) of the retailer whose advertisement linked to landing page 600. Map 606 may be an image, or may be linked to a third-party online mapping service. In some embodiments, the location of the user may be detected or determined, for example via the Internet Protocol (IP) address of the user, and map 606 may be displayed or generated based on the user location. For example, if the retailer has multiple locations, map 606 may be generated to display one or more of the retailer locations nearest to the location of the user. In some embodiments, map 606 may also include directions to the mapped retailer locations. These directions may be determined from the nearest major thoroughfare, such as highways or major streets. In certain embodiments, a more specific user location may be determined via other information associated with the user or the user's computer, and directions may be provided from the more specific user location.

In some embodiments, landing page 600 may include hyperlink 608, which may be linked to a different web page. When a user selects hyperlink 608, the different webpage may be displayed. In certain embodiments, the different web page may be a web page associated with the retailer. For example, the different web page may be the home page of the retailer, or may be a web page depicting one or more products that the retailer sells. In one embodiment, hyperlink 608 may lead to a web page associated with the product or products described and/or mentioned in advertisement 602 and/or coupon 604. Optionally, the user may be provided an option to purchase the advertised product or products from that web page. In some embodiments, a user selection of hyperlink 608 may automatically display a purchase page for the advertised product or products. In other embodiments, the different web page may be a web page associated with the product manufacturer, such as the manufacturer home page or a manufacturer web page describing the advertised product and/or products. In one example, a user who entered a search query for “Simmons king mattress” is directed to a web page that only shows king mattresses manufactured by Simmons® and sold by the retailer. In other example, a user who entered a search query for “Simmons Beautyrest” is directed to a web page that only shows mattresses from the Beautyrest® product line manufactured by Simmons® and sold by the retailer.

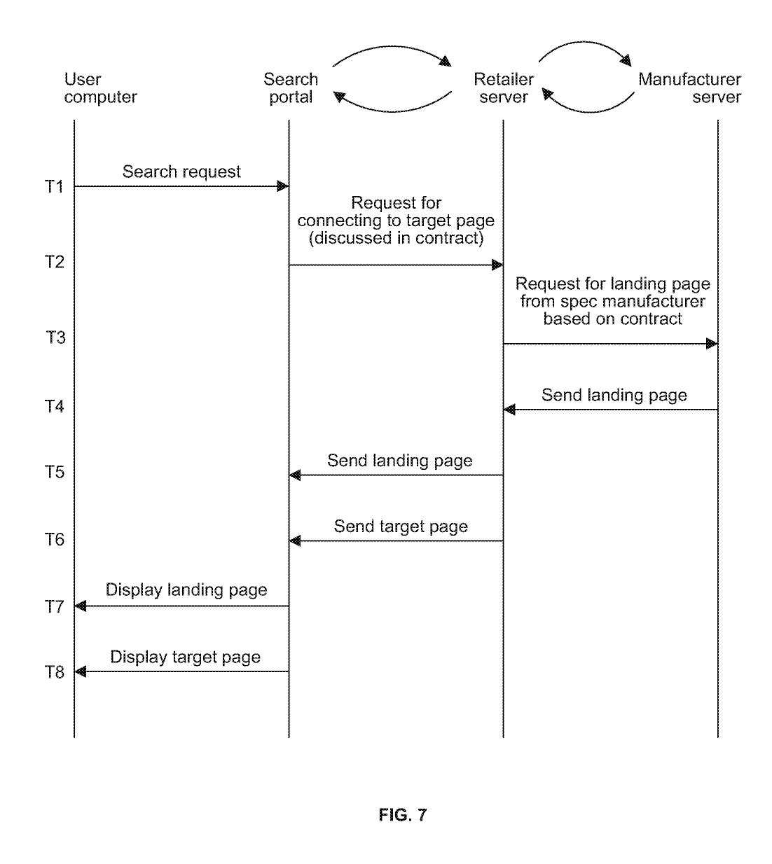

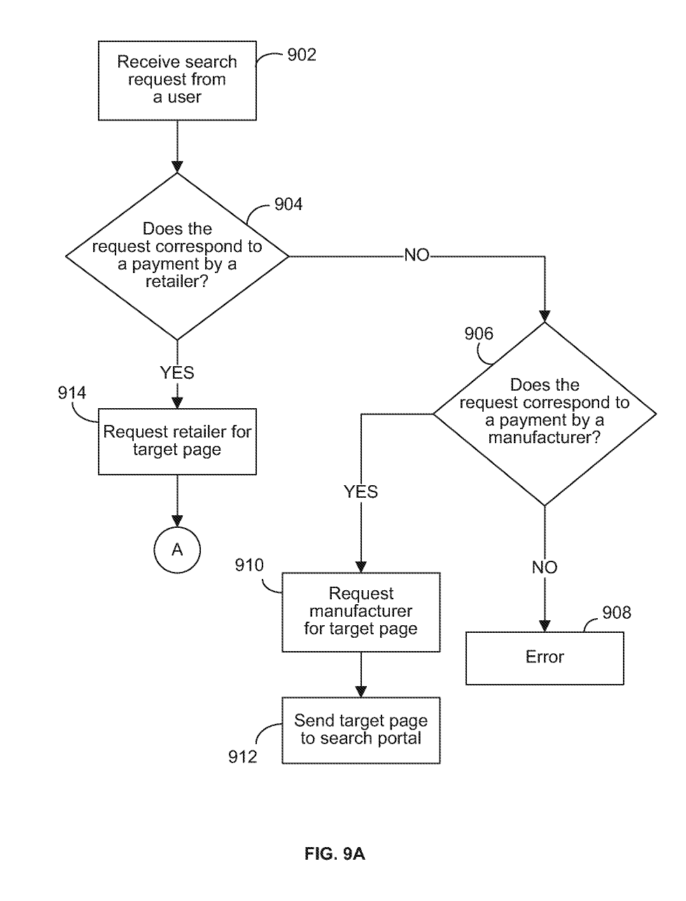

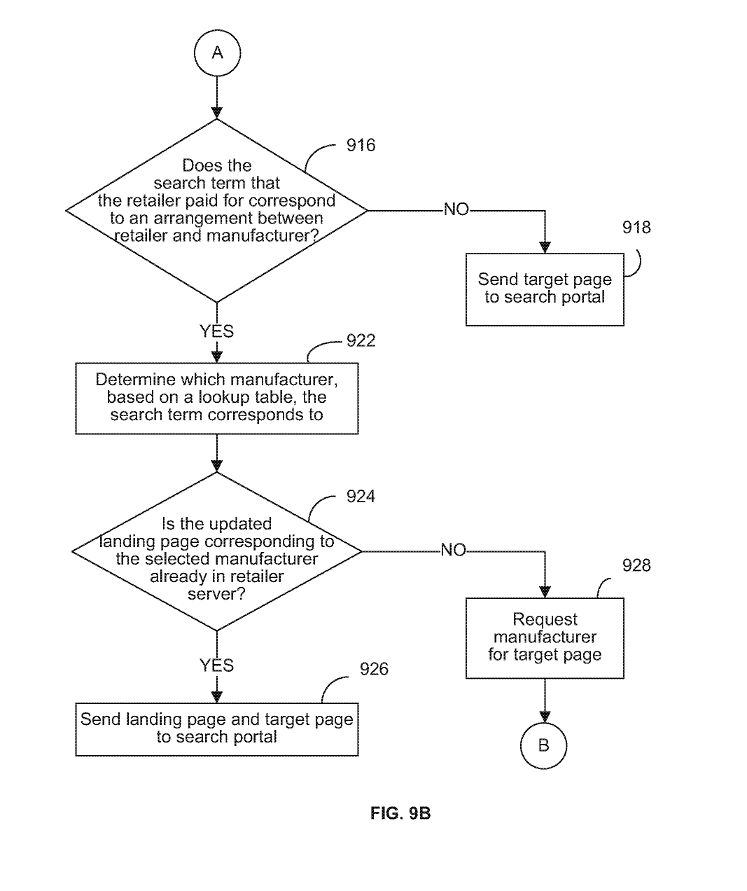

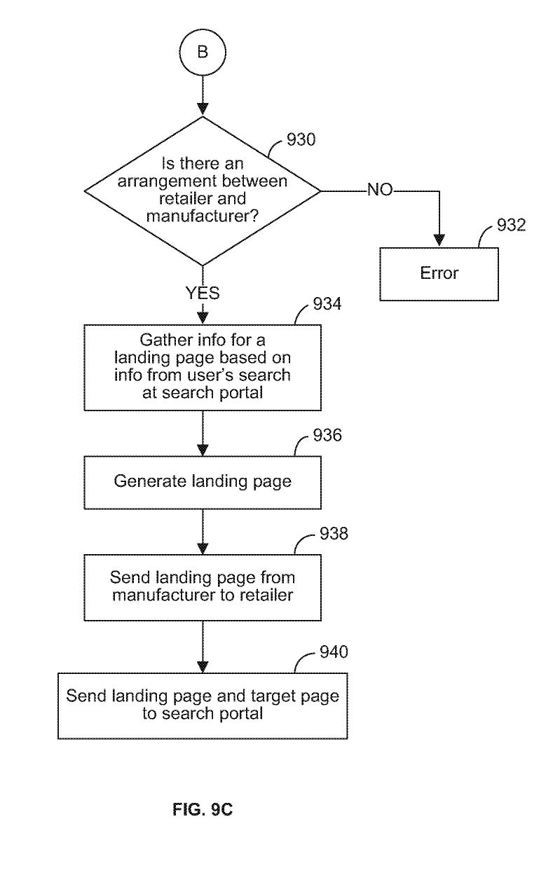

FIG. 7 depicts an embodiment of a process for generating and displaying a landing page. At time step T1, the user may enter a search term, e.g., “Simmons”, at a search portal web page. The search portal may generate a search results web page for display to the user (e.g., 500 in FIG. 5). The user may then click on a sponsored link associated with a retailer on the web page. At time step T2, the search portal may send a web page request to a retailer server. At time step T3, the retailer server may request a manufacturer server for a landing page for display to the user. At time step T4, the manufacturer server may select content and generate a landing page to send back to the retailer server. At time step T5, the retailer server may forward the landing page (e.g., 108 in FIG. 1) to the search portal for display to the user. At time step T6, the retailer server may send a retailer web page (e.g., 110 in FIG. 1) to the search portal. At time steps T7 and T8, in response to user input, the search portal may display the landing page and the retailer web page to the user. In particular, FIGS. 9A-9C depict flow diagrams for the operation of a system for generating a landing page according to the process depicted in FIG. 7. As described above, at time step T1, the user may enter a search term at a search portal web page. As shown in step 902 of FIG. 9A, a search portal (e.g., 304 in FIG. 3) of the landing page system receives a web page request from a user. For example, a user may enter search term “Simmons” at the search portal web page. The search portal may generate a web page that is transmitted back to be displayed to the user. The web page may include search results, including links that point to web sites related to the search terms submitted by the user, and may also include a set of hypertext links as sponsored links. The sponsored links may point to the servers of companies and entities that have purchased space on the web page. On clicking on a sponsored link, the search portal may check if the request corresponds to a link that has been paid for by a retailer (step 904). If the sponsored link has not been paid for by a retailer, the search portal may check whether it has been paid for by a manufacturer (step 906). If so, at step 910, the web page request is forwarded to a manufacturer server (e.g., 310 in FIG. 3). At step 912, the target page is displayed to the user. If the sponsored has not been paid for by a retailer or manufacturer, the link may be broken, and therefore, an error may be raised and sent to the search portal (step 908). In addition, the retailer server may send a retailer web page (e.g., 110 in FIG. 1) to the search portal for display to the user.

Next, as described in time step T2, the search portal sends a web page request to a retailer server. Following from step 904, if the sponsored link has been paid for by a retailer, the request is forwarded to a retailer server at step 914 (e.g., 308 in FIG. 3). At step 916, the retailer server checks whether the search term is associated with an agreement between the retailer and a manufacturer. If not, at step 918, the retailer server sends a retailer web page (e.g., 110 in FIG. 1) to the search portal for display to the user. If an agreement is found, at step 922, the retailer server determines the manufacturer named in the agreement from, e.g., a lookup table. At step 924, the retailer server may check if an updated landing page corresponding to the manufacturer already exists in server memory or storage. If the page is found, at step 926, the retailer server forwards the landing page and retailer web page to the search portal for display to the user. However, if not found, at step 928 (corresponding to time step T3 of FIG. 7), the retailer server requests a manufacturer server (e.g., 310 in FIG. 3) for the landing page.

At step 930, the manufacturer server determines whether an arrangement exists between the requesting retailer and the manufacturer. If not found, at step 932, the manufacturer server sends an error message back to the retailer server. In such a case, the retailer server may send a retailer web page (e.g., 110 in FIG. 1) to the search portal for display to the user. If an agreement is found, at step 934, the manufacturer server selects the content for the landing page, e.g., based on the search string entered by the user at the search portal. At step 936, the manufacturer server may generate the landing page. At step 938 (corresponding to time step T4 of FIG. 7), the manufacturer server may send the landing page to the retailer server. At step 940 (corresponding to time steps T5 of FIG. 7), the retailer server may forward the landing page and retailer web page to the search portal for display to the user. As described above, at time step T6, the retailer server may send a retailer web page (e.g., 110 in FIG. 1) to the search portal. At time steps T7 and T8, in response to user input, the search portal may display the landing page and the retailer web page to the user. In some embodiments, the retailer server may interact directly with the user system (e.g., 306 in FIG. 3) and send web pages to the user system instead of the search portal. In some embodiments, at step 936, the manufacturer server may send the selected content to the retailer server to generate the appropriate landing page. For example, the retailer web page may place the received content in a template web page for display to the user.

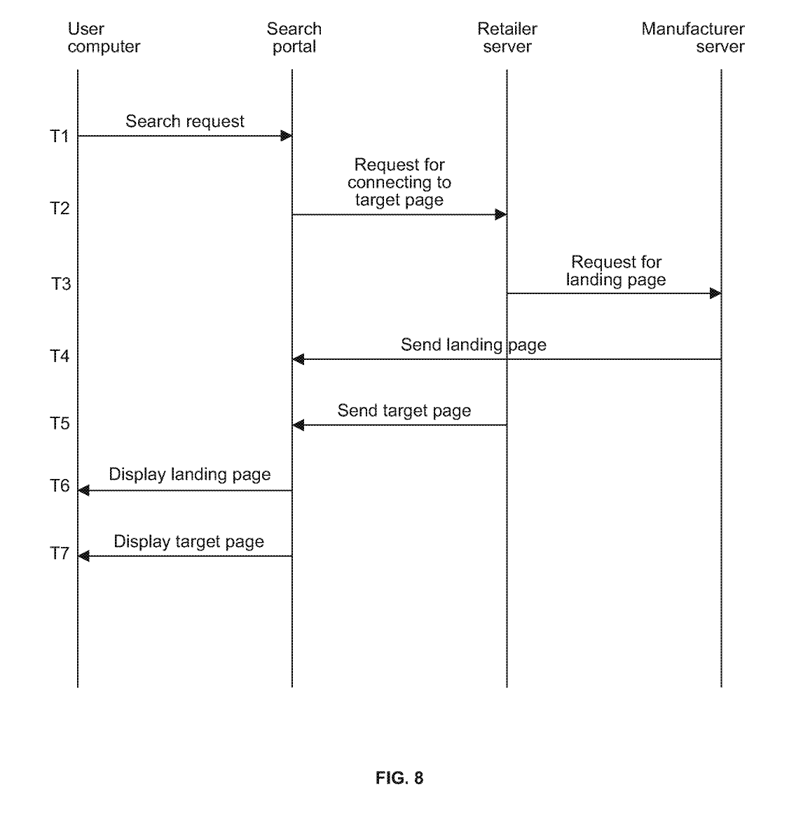

FIG. 8 depicts an alternative embodiment of a process for generating and displaying a landing page. Similar to the process described in FIG. 7, at time step T1, the user may enter a search term, e.g., “Simmons”, at a search portal web page. The user may then click on a sponsored link associated with a retailer when shown the search results web page. At time step T2, the search portal may send a web page request to a retailer server. At time step T3, the retailer server may request a manufacturer server for a landing page for display to the user. At time step T4, the manufacturer server may select content and generate a landing page, and then send the landing page directly to the search portal. At time step T5, the retailer server may send a retailer web page (e.g., 110 in FIG. 1) to the search portal. At time steps T6 and T7, in response to user input, the search portal may display the landing page and the retailer web page to the user.

Variations, modifications, and other implementations of what is described may be employed without departing from the spirit and scope of the invention. More specifically, any of the method and system features described above or incorporated by reference may be combined with any other suitable method or system feature disclosed herein or incorporated by reference, and is within the scope of the contemplated inventions. The systems and methods may be embodied in other specific forms without departing from the spirit or essential characteristics thereof. The foregoing embodiments are therefore to be considered in all respects illustrative, rather than limiting of the invention.

What is claimed is:

1. A system for generating a landing page, comprising:
a network interface, in communication with a processor, for communicating with a network;
a memory, in communication with the processor, for storing a database; and
a processor for:
receiving, through the network interface, a request for a web page associated with a retailer and having a web link that includes information to identify a type of product sold by the retailer and manufactured by one or more manufacturers;
sending to a user a landing page displaying content representative of a plurality of versions of the type of product sold by the retailer, each version being associated with a selected one of the manufacturers;
determining whether an advertising payment is received;
selecting, from the database, the content for the landing page based on the advertising payment received from each manufacturer; and
generating the landing page with the selected content for display to the user.

2. The system of claim 1, wherein the landing page includes content related to versions manufactured by a first manufacturer of the one or more manufacturers.

3. The system of claim 1, wherein the landing page includes content comparing versions manufactured by a first manufacturer and a second manufacturer of the one or more manufacturers.

4. The system of claim 1, wherein the landing page is controlled by the retailer, the one or more manufacturers, or a combination.

5. The system of claim 1, wherein the web link is associated with an advertisement or search engine result.

6. The system of claim 1, further comprising:
identifying an originating location of the request from the included web link;
determining one or more rules associated with the originating location; and
selecting, from the database, the content for the landing page based on the determined one or more rules.

7. The system of claim 6, wherein
the web link includes information identifying one or more of a Uniform Resource Locator (URL), an Internet Protocol (IP) address, and an entity associated with a website that includes the web link, and
the originating location is based on the identifying information included in the web link.

8. The system of claim 7, wherein the web link includes information identifying the region where the website is hosted.

9. A system for generating a landing page, the method comprising:
a network interface, in communication with the processor, for communicating with a network;
a memory, in communication with the processor, for storing a database;
a processor for:
receiving, through the network interface, a request for a web page associated with a retailer and having a web link that includes information to identify a type of product sold by the retailer and manufactured by one or more manufacturers;
determining whether an advertising payment is received from a selected manufacturer;
in response to determining that the advertising payment is received, sending to a user a landing page displaying content representative of a plurality of versions of the type of product manufactured by the selected manufacturer;
retrieving, from the database, the content for the landing page provided by the selected one of the manufacturers; and
generating the landing page with the retrieved manufacturer provided content for delivery to the user.

10. A method for generating a landing page implemented on processing circuitry in communication with a network interface and a memory comprising a database, the method comprising:
receiving, through the network interface, a request for a web page associated with a retailer and having a web link that includes information to identify a type of product sold by the retailer and manufactured by one or more manufacturers;
sending to a user a landing page displaying content representative of a plurality of versions of the type of product sold by the retailer, each version being associated with a selected one of the manufacturers;
selecting, from the database, the content for the landing page; and
generating, through the processing circuitry, the landing page with the selected content for display to the user.

11. A method for generating a landing page implemented on processing circuitry in communication with a network interface and a memory comprising a database, comprising:
receiving, through the network interface, a request for a web page associated with a retailer and having a web link that includes information to identify a type of product sold by the retailer and manufactured by one or more manufacturers;
sending to a user a landing page as a function of an advertising payment from each manufacturer, wherein the landing page is controlled by a selected manufacturer, and wherein the landing page displays content representative of a plurality of versions of the type of product associated with the selected manufacturer;
retrieving, from the database, the content for the landing page provided by the selected one of the manufacturers; and
generating, through the processing circuitry, the landing page with the retrieved manufacturer provided content for display to the user.
